(19) United States
(12) Patent Application Publication
(10) Pub. No.: US 2007/0002496 A1
(43) Pub. Date: Jan. 4, 2007

(54) Actuator coil support for enhanced performance

(75) Inventors: Roy Lynn Wood, Jordan, MN (US); Roger Alan Resh, Prior Lake, MN (US)

Correspondence Address: Derek J. Berger, Seagate Technology LLC, Intellectual Property - COL2LGL, 389 Disc Drive, Longmong, CO, 80503, US

(73) Assignee: Seagate Technology LLC

(21) Appl. No.: 11/172,101

(22) Filed: Jun. 30, 2005

(51) Int. Cl. G11B 5/55

(52) U.S. Cl. 360/265.8

(57) ABSTRACT

A coil support apparatus is provided that is configured for supporting a moveable coil within a magnetic field in a voice coil motor. The apparatus comprises a support arm with a characteristic cross section defining a first portion with a thickness related to a thickness of the coil for providing a mounting surface for attaching the coil. The support arm further defines a discontinuous second portion extending from the first portion in a direction away from the coil with a thickness substantially smaller than the first portion thickness. In some embodiments an actuator assembly is provided comprising a T-beam coil support.

### FIELD OF THE INVENTION

The claimed invention relates generally to the field of data transfer device performance and more particularly without limitation to optimizing the structural arrangement of an actuator coil support in order to reduce its moment of inertia while increasing the frequency of the system mode in the structural response.

### BACKGROUND

Data storage devices employ actuators to position data storing and retrieving heads with extremely abrupt accelerations and high velocities. Storage densities have dramatically increased while access times have dramatically decreased, making attention paid to resonant performance of the actuator all the more important a part of reliable data transfer.

Where a rotary actuator is positioned by a voice coil motor, the actuator body and the bearing supporting it function as a lever and fulcrum, respectively, transferring the forces from the voice coil motor at one end of the actuator to precise movement of the data transfer elements at the other end of the actuator. The structural response of the actuator to these forces, such as determined by the mass, inertia, and rigidity of the actuator, is deterministic of the performance of the data storage device in terms of seek time and settle time.

What is needed is a meaningful structural supporting solution for supporting the electrical coil of the voice coil motor by the actuator body; one that optimizes the mass distribution of the actuator so as to minimize inertia while maximizing the modal frequency of the overall structural response. It is to these improvement features that the embodiments of the present invention are directed.

### SUMMARY OF THE INVENTION

Embodiments of the present invention are generally directed to an actuator assembly of a data storage device.

In some embodiments an actuator assembly is provided comprising a T-beam coil support.

In some embodiments a coil support apparatus is provided that is configured for supporting a moveable coil within a magnetic field in a voice coil motor. The apparatus comprises a support arm with a characteristic cross section defining a first portion with a thickness related to a thickness of the coil for providing a mounting surface for attaching the coil. The support arm further defines a discontinuous second portion extending from the first portion in a direction away from the coil with a thickness substantially smaller than the first portion thickness.

In some embodiments a data storage device is provided comprising an actuator that is positionable by a voice coil motor comprising an electrical coil disposed within a magnetic field, and means for supporting the electrical coil by the actuator to reduce the actuator inertia.

These and various other features and advantages which characterize the claimed invention will become apparent upon reading the following detailed description and upon reviewing the associated drawings.

### BRIEF DESCRIPTION OF THE DRAWINGS

FIG. 1 is an exploded isometric view of a data storage device in which embodiments of the present invention can be implemented.

FIG. 2 is an isometric view of a portion of an actuator assembly constructed in accordance with embodiments of the present invention.

FIG. 3 is a cross sectional view taken along the line 3-3 of FIG. 2.

FIGS. 4-6 are cross sectional views similar to FIG. 3 but of actuator assemblies constructed in accordance with equivalent alternative embodiments of the present invention.

### DETAILED DESCRIPTION

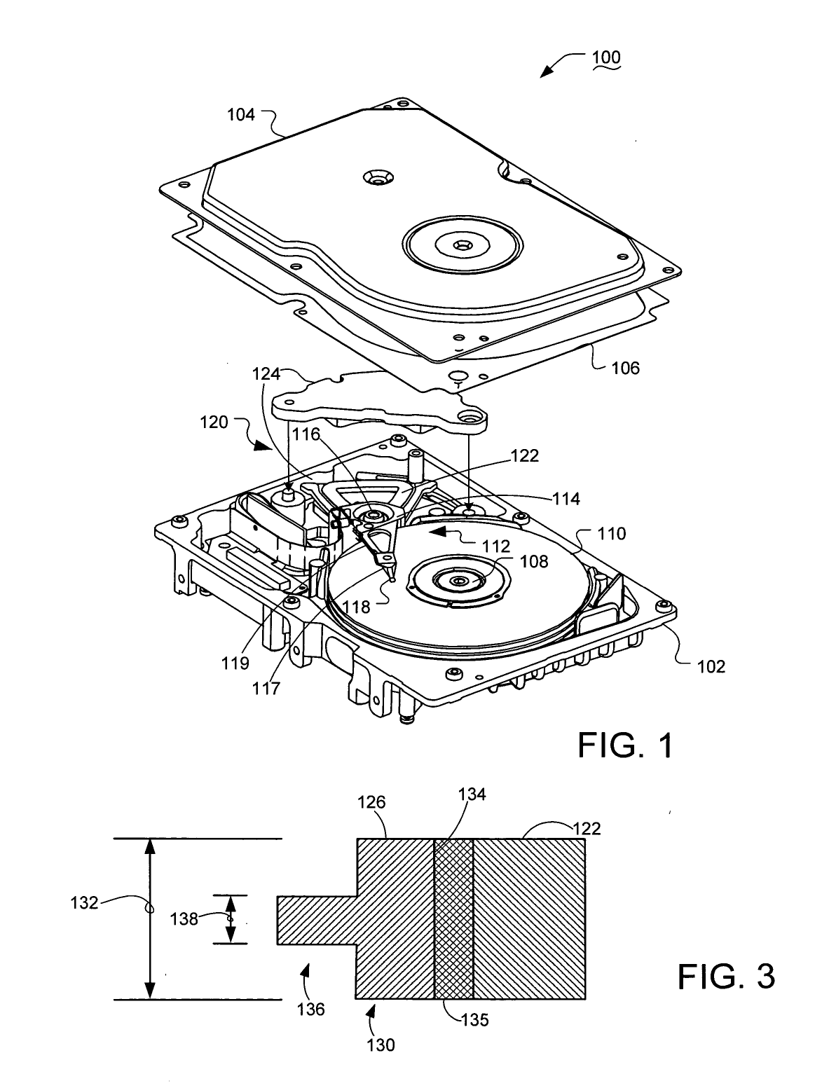

Turning to the drawings as a whole and particularly now to FIG. 1 which is an exploded isometric view of a data storage device 100 in which embodiments of the present invention can be practiced. The data storage device 100 has a base 102 to which a cover 104 is attached with a sealing member 106 sandwiched therebetween to establish a sealed enclosure. Within the enclosure a spindle motor 108 rotates one or more data storage mediums (“discs”) 110. Each of the discs 110 is formatted to define tracks in which data is recorded.

An actuator assembly, such as a rotary actuator 112, has a central body (or “eblock”) 114 that is pivotable around a bearing 116 to place a data transfer head 118 in a data transfer position in relation to a desired track. A suspension assembly 117 connected to an arm 119 portion of the body 114 joins the head 118 to the body 114. The head 118, in addition to having read and write elements, also has a slider assembly for flying the head 118 on a fluid bearing created by spinning the discs 110.

A motor, such as a voice coil motor 120, pivots the actuator 112 in order to move the heads 118 radially across the discs 110 to access the tracks. The voice coil motor 120 includes an electrical coil 122 mounted on the side of the actuator body 114 opposite the heads 118 so as to be immersed in the magnetic field of an array of permanent magnets 124. When controlled DC current is passed through the coil 122, an electromagnetic field is set up that interacts with the magnetic field of the permanent magnets 124 and causes the coil 124 to move relative to the permanent magnets 126 in accordance with the well-known Lorentz relationship.

The response of the actuator 112 to the forces imparted to it by the voice coil motor 120 is deterministic in part of the data storage performance, when measured in terms of track actual seek time. The actual seek time is the sum of the move time (the time required to move the head 118 from a particular track to a target track) and the settle time (the time required to align the head 118 adequately with the target track to enable a data transfer relationship therebetween). During reduction to practice of the embodiments of the present invention it has been observed that increases in data transfer bandwidth result by increasing the modal frequencies of the actuator 112 structural response. Furthermore, structural integrity of the actuator 112 is relevant because it has been observed that out-of-plane coil 122 modes adversely affect the settle time. The embodiments of the present invention are directed to tuning the modal frequency response of the actuator by novel improvements to the structure of the actuator 112, particularly in relation to the manner of supporting the coil 122.

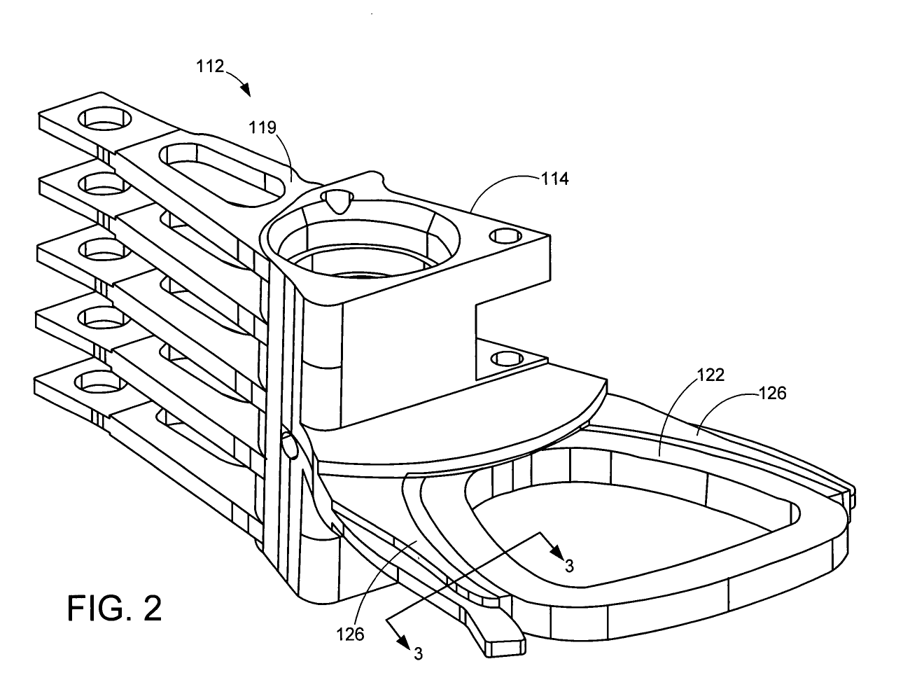

FIG. 2 is an enlarged isometric view of the body 114 portion of the actuator 112 with the coil 122 attached thereto. FIG. 3 is a cross sectional view taken along the line 3-3 of FIG. 2. The body 114 has a support arm 126 extending away from and opposing the arms 119 that support the suspension assemblies 117. In the embodiments illustrated, the body 114 has a pair of support arms 126 defining a yoke that receivingly engages the coil 122 on opposing sides thereof. Generally, the support arms 126 of the embodiments of the present invention define structural support members of reduced mass in comparison to a supporting member otherwise having a constant cross sectional size.

Particularly, FIG. 3 best shows the support arm 126 has a characteristic cross section defining a first portion 130 with a thickness 132 related to a thickness of the coil 122 for providing a mounting surface 134 for attaching the coil 122. A layer of a bonding agent 135 is shown joining the mounting surface 134 of the first portion 130 and the coil 122. In alternative equivalent embodiments the bonding agent 135 can be eliminated by overmolding the coil support 126 to the coil 122.

The support arm 126 also defines a discontinuous second portion 136 extending from the first portion 130 in a direction away from the coil 122 with a thickness 138 that is substantially smaller than the first portion thickness 132. Where the coil 122 is adhered to the support arm 126, or where the support arm 126 is overmolded to the coil 122, it can be advantageous to provide the first portion thickness 132 as being substantially the same thickness as the coil 122 in order to provide a full mating engagement between the mounting surface 134 and the coil 122.

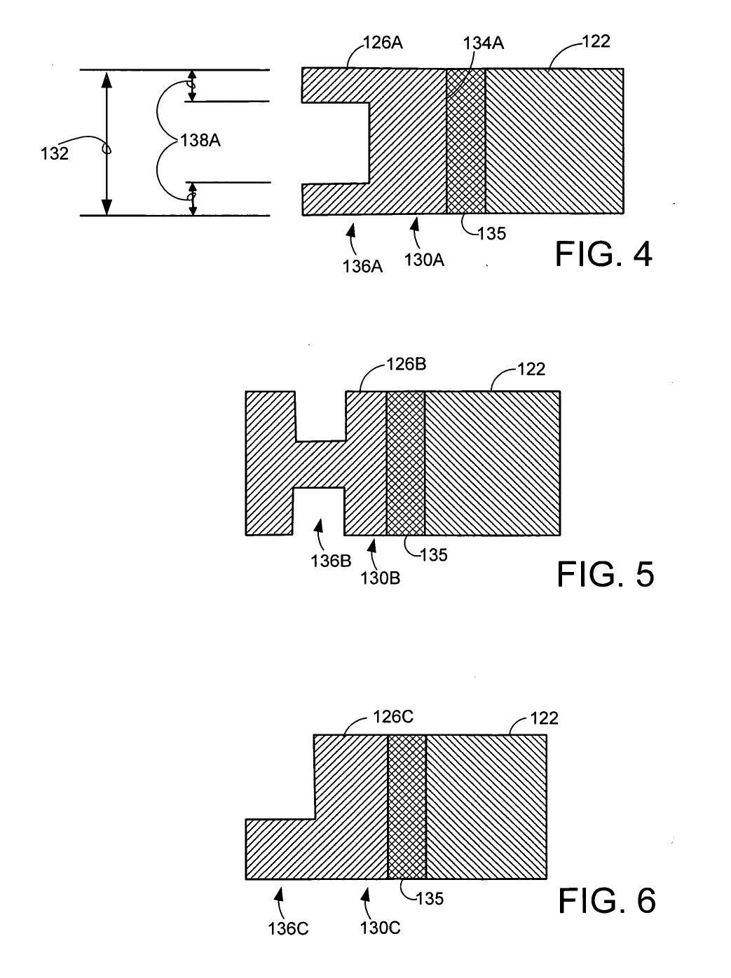

In the embodiments of FIGS. 2 and 3 the support arm 126 can be characterized as a T-beam support member, such that the first portion 130 is disposed substantially in transverse relation to the second portion 136, and the second portion 136 bisects the first portion 130. In alternative equivalent embodiments, such as the C-beam of FIG. 4, the second portion 136A can define two or more discreet members which define thicknesses 138A that together are substantially smaller than the first portion thickness 132. Preferably, in these latter embodiments the two or more discreet members are disposed symmetrically with respect to a longitudinal centerline of the first portion 130A.

FIGS. 5 and 6 further illustrate alternative equivalent embodiments of reduced-mass actuators with support arms 126 characterized as I-beam and L-beam support members.

The embodiments of the present invention can be used advantageously to provide a relatively larger actuator but with reduced move time and increased modal frequencies. For example, testing was conducted by comparing to a baseline model employing actuator support arms that were substantially rectangular shaped and supported a coil with 83 turns. A new actuator with T-beam support arms was produced in accordance with embodiments of the present invention to support a larger coil having 84 turns. Although the overall mass of the actuator assembly increased by 1.2% because of the larger coil (from 4.25E-05 to 4.30E-05 grams), the moment of inertia for the actuator decreased by 2.3% (from 9.67E-06 to 9.45E-06). The torque constant was advantageously reduced by 3.9% (from 7.386 to 7.100). Accordingly, the larger actuator support constructed in accordance with embodiments of the present invention provided substantially the same move time as the baseline actuator because of the improved dynamic structural properties.

The embodiments of the present invention furthermore provide a more efficient arrangement of a given mass for enhancing the structural integrity of the coil support. For example, the larger test actuator constructed in accordance with embodiments of the present invention provided a 23% improvement in coil and yoke first bending frequency and a 28% improvement in coil and yoke first torsion frequency, as compared to the baseline model. Overall, the T-beam actuator provided a 2.8% improvement of the system mode in the structural response of the actuator assembly.

Summarizing, the embodiments of the present invention generally contemplate a coil support apparatus (such as 112) configured for supporting a moveable coil (such as 122) within a magnetic field in a voice coil motor (such as 120). The coil support apparatus comprises a support arm (such as 126) with a characteristic cross section defining a first portion (such as 130) with a thickness (such as 132) related to a thickness of the coil for providing a mounting surface (such as 134) for attaching the coil. The support arm further defines a discontinuous second portion (such as 136) extending from the first portion in a direction away from the coil, and having a thickness (such as 138) substantially smaller than the first portion thickness.

The first portion can be substantially the same thickness as the coil, or as otherwise needed for the selected manner of attaching the coil to the mounting surface. The second portion can define one or more members that are unitarily constructed with the first portion and which extend substantially in transverse relation to the first portion. Where two or more members make up the second portion, then the members together define a thickness that is substantially smaller than the first portion thickness, and preferably the two or more members are symmetrically disposed in relation to the first member. The support arms can have cross sectional characteristics defining a structural support member such as a T-beam, an I-beam, a C-beam, and an L-beam.

In some embodiments the support apparatus comprises two support arms defining a yoke that is configured for receivingly engaging the coil between opposing mounting surfaces.

In alternative characterizations the embodiments of the present invention contemplate an actuator assembly in a data storage device comprising a T-beam coil support. The T-beam coil support can define a yoke for receivingly supporting an electrical coil with opposing mounting surfaces. The T-beam coil support can define a mounting surface for an electrical coil that is substantially the same thickness as the coil. Preferably, the T-beam coil support is unitarily constructed.

In other characterizations the embodiments of the present invention contemplate a data storage device comprising an actuator that is positionable by a voice coil motor comprising an electrical coil disposed within a magnetic field, and means for supporting the electrical coil by the actuator to reduce the actuator inertia. The means for supporting can be characterized by sizing a mounting portion of the support arm in relation to a thickness of the electrical coil and relatively reducing other portions of the support arm for decreasing the mass of the actuator. The means for supporting can be characterized by sizing the mounting portion no larger than needed for mounting the electrical coil. The means for supporting can be characterized by disposing the mounting portion substantially in transverse relation to the other portions. The means for supporting can be characterized by a unitarily constructing the support arm. The means for supporting can be characterized by the other portions defining two or more discreet members which together define a thickness substantially smaller than the mounting portion thickness. The means for supporting can be characterized by defining a yoke configured for receivingly engaging the coil between opposing mounting surfaces. The means for supporting can be characterized by a support arm defining a structural beam satisfying preselected requirements for strength and mass.

For purposes of this description and the appended claims, the term “means for supporting” expressly does not include previously attempted solutions involving an actuator with a support arm having a substantially constant-thickness through two or more parallel planes located at different lateral distances from the mounting surface. For example, the term “means for supporting” does not contemplate the shell extensions disclosed in U.S. Pat. No. 6,751,068 to Kant and assigned to the assignee of the present invention. This is because the shell extensions supporting the coil in Kant '068, best viewed in FIG. 15 there, are of substantially constant cross-sectional thickness at planes passing through the mounting surface, through the outer edge, and through parallel planes therebetween.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular processing environment without departing from the spirit and scope of the present invention.

In addition, although the embodiments described herein are directed to a data storage system, it will be appreciated by those skilled in the art that the claimed subject matter is not so limited and various other processing systems can utilize the embodiments of the present invention without departing from the spirit and scope of the claimed invention.

What is claimed is:

1. A coil support apparatus configured for supporting a moveable coil within a magnetic field in a voice coil motor, the apparatus comprising a support arm with a characteristic cross section defining a first portion with a thickness related to a thickness of the coil for providing a mounting surface for attaching the coil, and the support arm defining a discontinuous second portion extending from the first portion in a direction away from the coil with a thickness substantially smaller than the first portion thickness.

2. The apparatus of claim 1 wherein the first portion is substantially the same thickness as the coil.

3. The apparatus of claim 1 wherein the first portion is disposed substantially in transverse relation to the second portion.

4. The apparatus of claim 1 wherein the first and second portions are unitarily constructed.

5. The apparatus of claim 1 wherein the second portion defines two or more discreet members which together define a thickness substantially smaller than the first portion thickness.

6. The apparatus of claim 5 wherein the two or more discreet members are disposed symmetrically with respect to a longitudinal centerline of the first portion.

7. The apparatus of claim 1 comprising two support arms defining a yoke configured for receivingly engaging the coil between opposing mounting surfaces.

8. The apparatus of claim 3 wherein the first and second portions define a T-beam.

9. An actuator assembly in a data storage device comprising a T-beam coil support.

10. The assembly of claim 9 wherein the T-beam coil support defines a yoke for receivingly supporting an electrical coil with opposing mounting surfaces.

11. The assembly of claim 9 wherein the T-beam coil support defines a mounting surface for an electrical coil that is substantially the same thickness as the coil.

12. The assembly of claim 9 wherein the T-beam coil support is unitarily constructed.

13. A data storage device comprising:
an actuator that is positionable by a voice coil motor comprising an electrical coil disposed within a magnetic field; and
means for supporting the electrical coil by the actuator to reduce the actuator inertia.

14. The device of claim 13 wherein the means for supporting is characterized by sizing a mounting portion of a support arm in relation to a thickness of the electrical coil and relatively reducing other portions of the support arm for decreasing the mass of the actuator.

15. The device of claim 14 wherein the means for supporting is characterized by sizing the mounting portion no larger than needed for mounting the electrical coil.

16. The device of claim 14 wherein the means for supporting is characterized by disposing the mounting portion substantially in transverse relation to the other portions.

17. The device of claim 14 wherein the means for supporting is characterized by a unitarily constructed support arm.

18. The device of claim 14 wherein the means for supporting is characterized by the other portions defining two or more discreet members which together define a thickness substantially smaller than the mounting portion thickness.

19. The device of claim 14 wherein the means for supporting is characterized by defining a yoke configured for receivingly engaging the coil between opposing mounting surfaces.

20. The device of claim 14 wherein the means for supporting is characterized by a support arm defining a structural beam satisfying preselected requirements for strength, mass, and modal frequency response.
